(19) United States
(12) Patent Application Publication
(10) Pub. No.: US 2006/0083419 A1
(43) Pub. Date: Apr. 20, 2006

(54) Systems and methods for isolating parts

(76) Inventors: Michael Carbaugh, Winfield, WV (US); Masayuki Ono, Harricane, WV (US)

Correspondence Address: DINSMORE & SHOHL, LLP, 1900 CHEMED CENTER, 255 EAST FIFTH STREET, CINCINNATI, OH, 45202, US

(21) Appl. No.: 10/967,759

(22) Filed: Oct. 18, 2004

(51) Int. Cl. G06K 9/00

(52) U.S. Cl. 382/141

(57) ABSTRACT

A part isolation system of one embodiment includes an identification surface, a loader assembly having a drop point located above the identification surface and a vision system. The loader assembly may be configured to release a plurality of parts from the drop point onto the stationary identification surface for separation of the parts and recognition by the vision system.

### TECHNICAL FIELD

The present invention relates generally to systems and methods for isolating parts. More particularly, embodiments of the present invention relate to systems and methods for isolating a plurality of various parts for recognition by a vision system.

### BACKGROUND

Various production parts for manufacturing, such as nuts, bolts and castings, for example, are often shipped to the user of such parts mixed together in one box or bin. These miscellaneous parts therefore need to be unloaded from the box, separated and transferred to the appropriate conveyer for proper storage. It is currently known to unload and separate the parts using a variety of robots and vision systems. For example, a vision system is used to recognize and locate objects by comparing the viewed structure or image of the part to stored specifications for like parts. However, the vision system sometimes has difficulties recognizing individual parts, such as when parts are stuck together. To solve this problem, mechanical vibration systems were introduced to separate the parts on a conveyor belt through vibration so that all parts could be individually located by the vision system. The problem with mechanical vibration systems, however, is that many mechanical parts are needed to operate the systems, and these parts often wear out and need to be replaced.

As such, there is a need for part isolation systems that are low maintenance and are configured to more efficiently remove a variety of parts from a receptacle, separate the parts for recognition by a vision system and transport the same to a desired storage bin or conveyor system.

### SUMMARY OF THE INVENTION

Accordingly, the present invention is intended to address and obviate previous problems and shortcomings and otherwise improve previous part isolation systems.

According to some aspects of the present invention, a part isolation system is provided that comprises a stationary identification surface and a picker assembly comprising a loader assembly. The loader assembly has a drop point located above the identification surface. The loader assembly may be configured to release a plurality of parts from the drop point such that they fall onto the identification surface. The vision system may be configured to take an image of the parts after being dropped onto the surface and to compare the image in order to identify the parts and to control appropriate transfer of the parts based upon the identification.

According to additional aspects of the present invention, a part isolation system is provided that comprises a stationary identification surface and a picker assembly comprising a loader assembly. The loader assembly includes a feeder assembly and a gripper assembly. The feeder assembly may include a drop point located above the identification surface. The part isolation system may further comprise a vision system. The loader assembly may be configured to release a plurality of parts from the drop point such that they fall onto the identification surface. The vision system may be configured to take an image of the parts after being dropped onto the surface and to compare the image in order to identify the parts and to control appropriate transfer of the parts based upon the identification.

In accordance with other aspects of the present invention, a method is provided for isolating varying parts within a receptacle. The method comprises providing an identification surface, providing a loader assembly having a drop point located above the identification surface, removing the parts from the receptacle with the loader assembly and dropping the parts at the drop point onto the identification surface. The method may further comprise providing a vision system for recognizing the parts dropped onto the identification surface and removing at least one of the parts from the identification surface.

Still other embodiments, aspects, combinations, advantages and objects of the present invention will become apparent to those skilled in the art from the following descriptions wherein there are shown and described alternative illustrative embodiments of this invention for illustration purposes. As will be realized, the invention is capable of other different aspects, objects and embodiments all without departing from the scope of the invention. Accordingly, the drawings, objects, and description should be regarded as illustrative and exemplary in nature only and not as restrictive.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a schematic view of an exemplary assembly for isolating parts in accordance with one embodiment of the present invention;

FIG. 2 is a partial schematic view of an exemplary loader assembly within an exemplary receptacle in accordance with another embodiment of the present invention;

FIG. 3 is a partial schematic view of an exemplary loader assembly loaded with parts and positioned at a drop point in accordance with another embodiment of the present invention;

FIG. 4 is a partial schematic view of the exemplary loader assembly of FIG. 3 with parts dropped on the identification surface in accordance with an illustrative embodiment of the present invention;

FIG. 5 is a partial schematic view of the exemplary loader assembly of FIG. 4 with the loader assembly in a gripping position in accordance with an illustrative embodiment of the present invention; and

FIG. 6 is a schematic view of an exemplary loader assembly configured to place a separated part in a storage assembly in accordance with an illustrative embodiment of the present invention.

### DETAILED DESCRIPTION OF ILLUSTRATIVE EMBODIMENTS

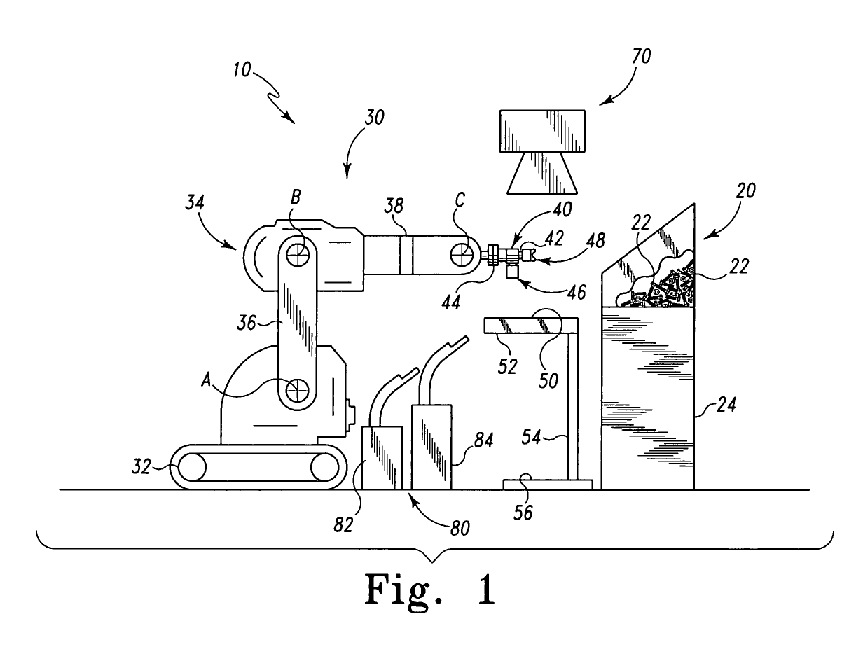

Referring to the drawing figures in detail, wherein corresponding numerals indicate the corresponding elements throughout the drawing figures, FIG. 1 illustrates a part isolation system 10 for separating a variety of parts. As illustrated, part isolation system 10 may comprise a receptacle 20, a picking assembly 30, an identification surface 50 and a vision system 70. As illustrated, the receptacle 20 may include a plurality of production parts 22 such as, for example, nuts, bolts and castings mixed together in a single barrel or box 24. Receptacle may be configured so that parts 22 are moved toward the top of barrel 24 for easy access by the loader assembly 40 such as by, for example, a weight-controlled hydraulic bottom plate associated with receptacle. As will be discussed, in one embodiment, the picking assembly 30 (e.g. including loader assembly 40) may be configured to remove a plurality of varying production parts 22 from the receptacle 24 for separation and transport to one or more storage bins 82 and 84 where the parts can be stored and/or utilized.

Still referring to FIG. 1, picking assembly 30 may comprise a base 32 with a flexible arm assembly 34 pivotally mounted thereto. Picking assembly 30 may be configured to be moveable about a floor of the manufacturing plant. As illustrated, flexible arm assembly 34 may comprise a mount arm 36 pivotally mounted to base 32 at pivot A and pivotally mounted to an extension arm 38 at pivot B. Flexible simply means that the arm assembly 34 can freely move into a number of different positions to move loader assembly 40 (discussed later herein) into a number of different positions during the separation process. Mount arm 36 and extension arm 38 may be configured to provide enhanced flexibility and reach of the picking assembly 30. In another embodiment, picking assembly 30, including mount arm 36 and extension arm 38, may comprise any number of arrangements configured to secure and manipulate loader assembly 40 so as to retrieve and transfer a plurality of parts to a selected destination. For example, in another embodiment, picking assembly 30 may be ceiling mounted and operated through pulleys or cables configured to raise and lower its loader assembly 40 into receptacle 20. Accordingly, the illustrated configuration of the base 32, the mount arm 36 and extension arm 38 should not be considered limiting and can be accomplished by a number of other mechanical or robotic arrangements.

As illustrated in FIGS. 1-6, a loader assembly 40 may be pivotally mounted to extension arm 38 such as at pivot C. It is believed that the pivotal mounting of the loader assembly 40 to the extension arm 38 in such fashion provides an enhanced range of mobility of the loader assembly 40 about the extension arm 38. Similar to the discussion above regarding the picking assembly 30, mount arm 36 and extension arm 38, it should be understood that attachment of the loader assembly 40 to other components of the picking assembly 30 can be accomplished through a variety of arrangements. For example, as illustrated, loader assembly 40 may comprise a shaft 42 rotatably secured within collar 44 such as by any conventional arrangement to allow shaft 42 to rotate 360° about collar 44 and relative to the extension arm 38. Such arrangement further enhances the mobility of the feeder and gripper assemblies (discussed later herein) for retrieving parts prior to or after isolation. Of course, in another embodiment, shaft 42 may be rigidly attached to collar 44 or pivotally attached to collar 44 such as via mount arm and extension arm, 36 and 38.

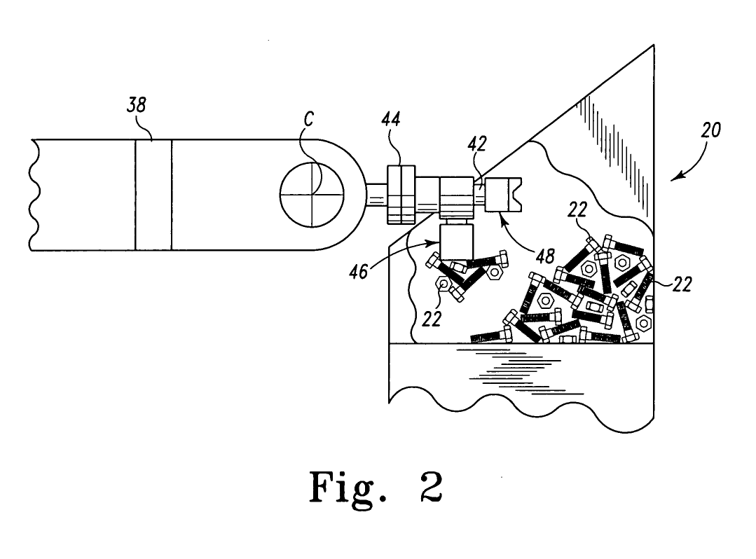

In one embodiment, shaft 42 may be configured so as to carry feeder assembly 46. Feeder assembly 46 may be configured to retrieve a plurality of parts 22 from a receptacle 20 and transport the plurality of parts 22 to an identification surface 50. Accordingly, feeder assembly 46 may comprise a magnet as illustrated in the illustrative embodiment, or other such apparatus including a mechanical claw, vice, clamp, fingers or other arrangements capable of retrieving parts from a receptacle and transporting the same to an identification surface 50. In an embodiment wherein the feeder assembly 46 is a magnet, a metal block may be selectively magnetized for attracting a plurality of parts 22 from a part receptacle 20 (e.g. FIG. 2). In addition, it is contemplated that the magnetic force may be varied depending on the size and/or number of parts to be retrieved. As will be discussed later herein, picking assembly 30 can position feeder assembly 46 into receptacle, and where feeder assembly 46 is a magnet, energize the magnet to attract a plurality of parts.

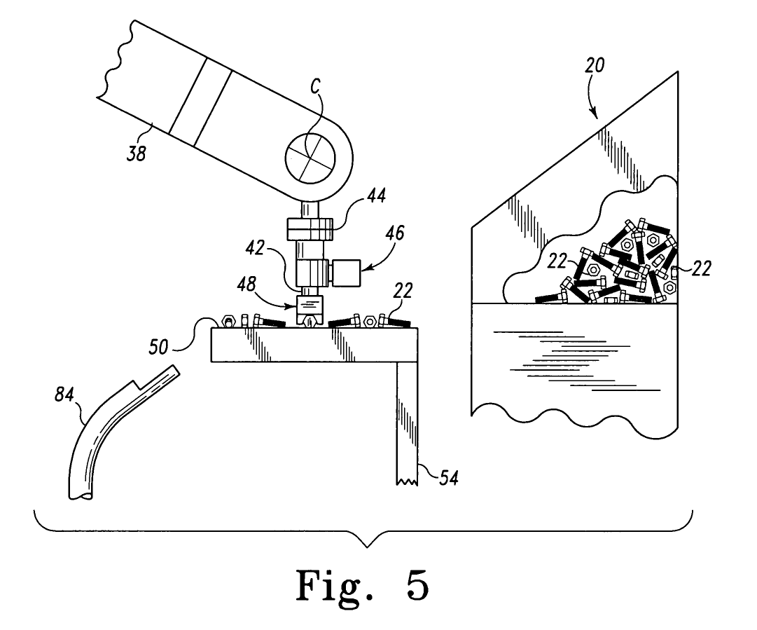

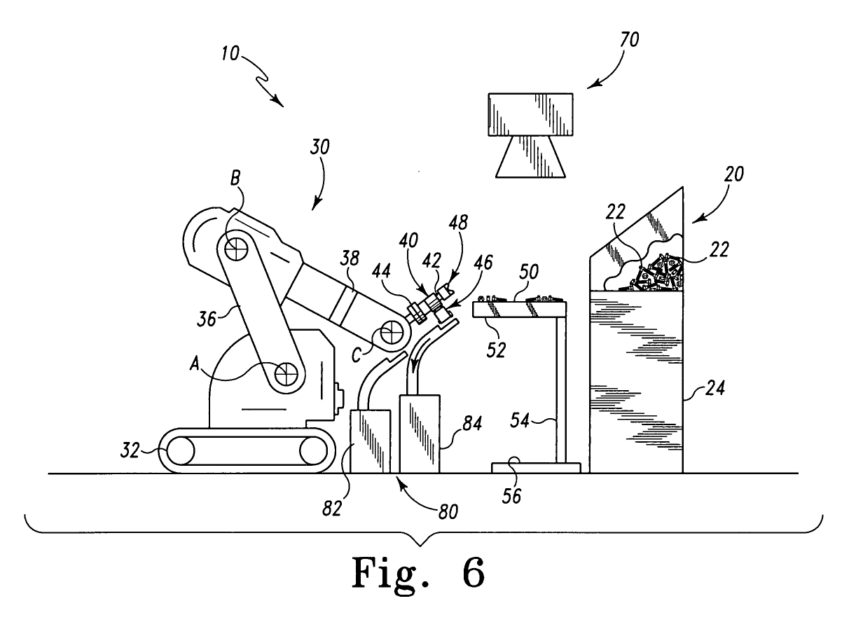

Still referring to FIGS. 1-6, loader assembly 40 may also comprise a gripper assembly 48 positioned at the distal or outermost end of the loader assembly 40. As illustrated, gripper assembly 48 may comprise a mechanical claw or other such clamp arrangement and be configured to retrieve one or more parts from a stationary identification surface 50 (e.g. FIG. 5). Accordingly, in one embodiment, it is contemplated that the picking assembly 30 can utilize its flexible arm assembly 34 to retrieve a plurality of parts 22 from a receptacle 20 with, for example, a feeder assembly 46 (e.g. magnet), drop the plurality of parts onto an identification surface 50 (discussed later herein) and then utilize a separate gripper assembly 48 to retrieve and transport one or more of the parts to a selected location (e.g. bins 82 and 84 in FIGS. 1 and 6). It should be understood, however, that any number of arrangements of the above components may be used in practice with the invention. For example, picking assembly 30 may comprise two separate mount arms and extension arms, wherein one set comprises a feeder assembly and the other set comprises a gripper assembly configured to work in conjunction with one another for isolating and transporting a plurality of parts. In another embodiment, loader assembly 40 may comprise two or more feeder assemblies 46 or two or more gripper assemblies 48. In yet another embodiment, loader assembly 40 may comprise only one claw, or only one magnet, for both loading and supplying. Accordingly, picker assembly 30 may comprise a number of components arranged in a variety of different embodiments all within the scope of the present invention.

As illustrated in the figures, part isolation system 10 further comprises an identification surface 50 located adjacent the picker assembly 30. Identification surface 50 may include a flat plate 52 suspended above floor with a post 54 and base 56, or alternatively, with just a base. Identification surface 50 may be supported at any distance above the floor. In addition, identification surface 50 may be any size or shape and comprise metal, wood, plastic or any other substance and combinations thereof.

A vision system 70 or camera may be located above the stationary identification surface 50 in order to identify and distinguish the parts 22 delivered to the identification surface 50 so that gripper assembly 48 may then remove and transport the parts to a storage assembly 80. Vision systems utilizing cameras for distinguishing parts are generally known in the art. One such system is manufactured by Omron (e.g. model F-160). Others include systems manufactured by ABB, Cognex, Banner and Epson, to name a few additional examples. The performance and maximum feed rate of the part isolation system is related to the feed rate and orientation of parts onto the identification surface passing into the camera field of view of the vision system used therewith. Because the vision system can not easily distinguish parts located one on top of the other for transport to the appropriate location, it is important to orient the parts on the identification surface in a manner that effectively separates the parts from one another.

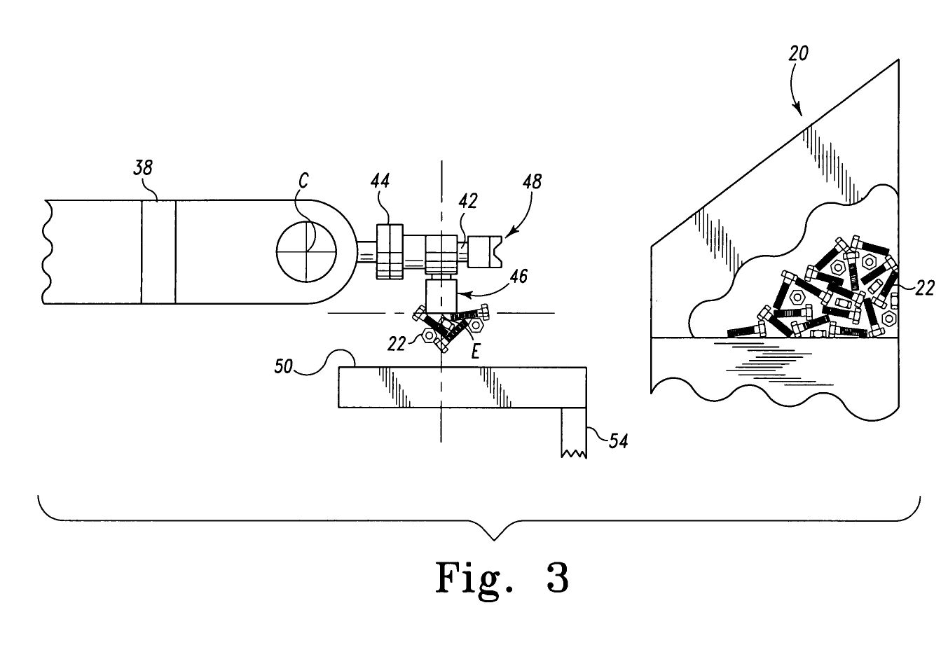

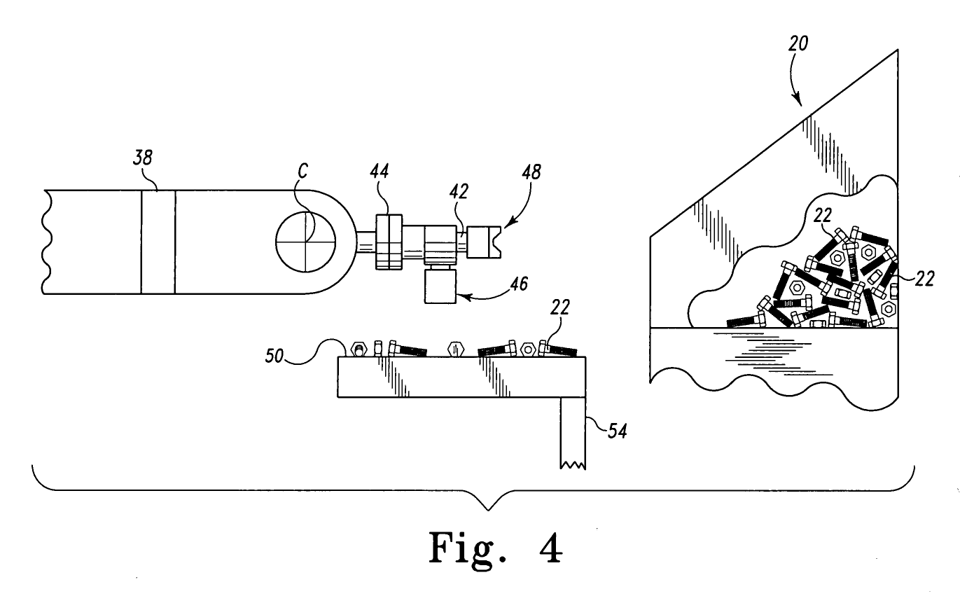

It is one aspect of the present invention to provide a stationary surface for delivery of a plurality of parts from a drop point E (e.g. FIG. 3) above the surface 50 in order to effectively separate the parts for view by the vision system 70. More particularly, referring to FIGS. 1-4, once a plurality of parts are retrieved from a receptacle 20, picker assembly 30 may position loader assembly 40 at a distance above the identification surface 50, such as at drop point E. As illustrated, drop point E may comprise the location above the identification surface 50 where the feeder assembly 46 releases the parts 22. It should be understood that drop point E may be located at any position above identification surface 50. In one embodiment, for example, drop point E may be approximately 2 inches (5 cm) from the identification surface 50. Once at the drop point E, the feeder 46 of the loader 40 (e.g., a magnet) may deenergize and release the parts 22 onto to identification surface (e.g. FIG. 4). The effective collision of the parts 22 against the stationary identification surface 50, as well as the collision of the parts themselves which often occurs after being dropped, separates the parts 22 so that the vision system 70 can recognize the same.

In the rare occasion that parts are still bound to one another once dropped onto the identification surface (e.g., as indicated by the vision system being unable to identify parts), loader assembly 40 may drop another plurality of parts onto the identification surface 50, which in turn will further separate the parts for the vision system. In another embodiment, a clearing arrangement, such as a mechanical arm may be used to sweep all of the parts on the identification surface 50 into the original 20 or spare receptacle. In yet another embodiment, identification surface 50 may be rotatably mounted to the post 54 so that when parts are bound together, the identification surface may rotate or pivot and drop the parts into the original or spare receptacle. Accordingly, the need for vibrators and other such moving mechanical separation equipment are eliminated.

The part isolation assembly 10 may further comprise a storage assembly 80 (as best shown in FIGS. 1 and 6). For ease of illustration, storage assembly 80 is shown as comprising two bins 82 and 84 each configured to accept one type of part separated with the picker assembly 30. More particularly, once parts are dropped onto identification surface 50 and recognized by vision system 70, vision system 70 will control the gripper assembly 48 to pick the desired part and transport the part to the appropriate storage bin 82 or 84 where like parts are stored. However, the storage bins 82 and 84 are but one type of assembly capable of being used with the present invention. In another embodiment, a moving belt conveyor system (not shown) may be positioned adjacent the picker assembly 30 to transport separated parts to desired locations. For example, one conveyor belt may transport separated parts directly to an assembly line for use by a worker, whereas another belt may transport separated parts to another storage bin. The picker assembly, based on information and control from the vision system can place the proper separated part on the proper conveyor belt. Because the systems used to transport parts separated by the picker assembly are numerous and comprise a variety of arrangements, such systems should not be limited to those described herein.

In use, feeder assembly 46 may be lowered into or near receptacle 20 and magnet may be energized to attract a number of parts for transport to identification surface 50 (e.g. FIG. 2). Once magnet is energized and parts are attracted, extension arm 38 will position the loader assembly 40 with parts attached to the feeder assembly at a drop point above identification surface 50 (e.g. FIG. 3). The magnet may then deenergize thereby dropping all attached parts onto identification surface 50 (e.g. FIG. 4). As the parts hit the identification surface 50, it is contemplated that the parts will separate from one another. To assist in separation, friction devices can be provided on the surface (e.g. fingers, extensions, ribs, groves). In one embodiment, another receptacle (not shown) may be positioned under the identification surface 50 to catch parts falling from the sides of the identification surface 50. In another embodiment, identification surface 50 may be bowed at its outer periphery to prevent such spilling of parts. The picker assembly 30 may move out of the field of view of the vision system 50. The parts located on the identification surface 50 may be scanned by vision system 70 which is configured to identify the type and size of parts and compare the image to stored specifications for like parts. For example, the vision system 70 may take a digital image of the surfaces with its parts and identify the parts by recognizing bitmap outlines of areas differing from blank surface. The system may then take each bitmap area, rotate it multiple times and compare with a saved bitmap for each part type during each rotation. If a match is found, the system may send an identification or control signal to gripper assembly to pick up that part (as indicated by its relative location in the overall area of surface) and place the part in the appropriate bin 82 or 84 depending on which type of part was identified as matching.

If the vision system 70 is capable of locating each separated part on plate 32 (e.g., no parts are stuck together), gripper assembly 48 may then be activated to remove identified parts from identification surface 50. More particularly, information regarding the type and size of part and its respective location on identification surface 50 may be delivered as signals or data to gripper assembly 48. In response thereto, gripper assembly 48 may swing toward identification surface 50, position itself over the appropriate part or number of parts, and pick up the same with claw or other gripping device (e.g. FIG. 5). Gripper assembly 48 may then transport the parts to one of the bins 82 or 84 of storage assembly 80 or to another conveyor system for routing the parts to their appropriate location for storage or production. If desired, parts may be transferred to a conveyor system in a pre-selected orientation to speed up the storage process of the part or production. Alternatively, if vision system 70 is unable to locate each part (e.g., some parts are stuck together), identification surface 50 may be pivoted, for example, to drop the parts into another receptacle. Accordingly, transportation of the parts from the receptacle 20 to the appropriate bin 82 or 84, or to a conveyor system in a correct orientation and in a low cost maintenance way is accomplished by the present design.

The foregoing description of the various embodiments of the invention has been presented for the purposes of illustration and description. It is not intended to be exhaustive or to limit the inventions to the precise forms disclosed. Many alternatives, modifications and variations will be apparent to those skilled in the art of the above teaching. For example, part isolation systems in accordance with the present inventions may comprise a variety of different arrangements and can include picking assemblies and conveyor systems of various configurations. Accordingly, while some of the alternative embodiments of a part isolation system have been discussed specifically, other embodiments will be apparent or relatively easily developed by those of ordinary skill in the art. Accordingly, this invention is intended to embrace all aspects, alternatives, modifications, variations and combinations that have been discussed or suggested herein, and others that fall within the spirit and broad scope of the claims.

What is claimed is:

1. A part isolation system comprising:
an identification surface;
a picker assembly comprising a loader assembly, said loader assembly having a drop point located above said identification surface; and
a vision system, wherein said loader assembly is configured to release a plurality of manufacturing parts from said drop point such that they fall onto said identification surface and wherein said vision system is configured to take an image of said parts after being dropped onto said surface and to compare said image in order to identify said parts and to control appropriate transfer of said parts based upon the identification.

2. The part isolation system as recited in claim 1, further comprising a receptacle positioned adjacent said identification surface configured for storage of said parts.

3. The part isolation system as recited in claim 1, further comprising a conveyor system configured for transfer of said parts after identification by said vision system.

4. The part isolation system as recited in claim 1, further comprising a storage assembly.

5. The part isolation system as recited in claim 1, wherein said identification surface comprises a clearing arrangement configured to clear a part from said surface if a part cannot be identified by said vision system.

6. The part isolation system as recited in claim 1, wherein said loader assembly comprises a feeder assembly configured to remove said plurality of parts from a receptacle.

7. The part isolation system as recited in claim 6, wherein said feeder assembly comprises a claw.

8. The part isolation system as recited in claim 6, wherein said feeder assembly comprises a magnet.

9. The part isolation system as recited in claim 1, further comprising a gripper assembly configured to remove each of said plurality of parts from said identification surface to a transfer location based upon the type of part identified by said vision system.

10. The part isolation system as recited in claim 9, wherein said gripper assembly comprises a claw.

11. The part isolation system as recited in claim 1, wherein said loader assembly is rotatably mounted to said picker assembly.

12. A part isolation system comprising:
a stationary identification surface;
a picker assembly comprising a loader assembly, said loader assembly including a feeder assembly and a gripper assembly, said feeder assembly having a drop point located above said identification surface; and
a vision system, wherein said feeder assembly is configured to release a plurality of manufacturing parts from said drop point such that they fall onto said identification surface and wherein said vision system is configured to take an image of said parts after being dropped onto said surface and to compare said image in order to identify said parts and to control appropriate transfer of said parts based upon the identification.

13. The part isolation system as recited in claim 12, wherein said loader assembly is rotatably mounted to said picker assembly.

14. The part isolation system as recited in claim 12, wherein said feeder assembly comprises a magnet.

15. The part isolation system as recited in claim 12, wherein said gripper assembly comprises a claw.

16. A method for isolating varying parts within a receptacle comprising:
providing an identification surface;
providing a loader assembly having a drop point located above said identification surface;
removing multiple parts from said receptacle using said loader assembly;
dropping said parts at said drop point onto said identification surface such that said parts fall onto and collide with said identification surface;
providing a vision system for recognizing said parts dropped onto said identification surface;
using the vision system to provide an identification signal indicating the identification of one of said parts;
removing at least one of said parts from said identification surface based upon said identification signal; and
moving said removed part to a location based upon said identification signal.

17. The method for isolating varying parts as recited in claim 16, further comprising providing a conveyor system for transporting said at least one of said parts removed from said identification surface.

18. The method for isolating varying parts as recited in claim 16, further comprising clearing at least one part from said identification surface when the vision system fails to provide an identification signal for said part.

19. The method for isolating varying parts as recited in claim 16, further comprising removing said parts from said receptacle with a feeder assembly associated with said loader assembly.

20. The method for isolating varying parts as recited in claim 16, further comprising transporting at least one of said parts removed from said identification surface to a storage assembly.
